(19) United States
(12) Patent Application Publication
(10) Pub. No.: US 2026/0258272 A1
(43) Pub. Date: Sep. 3, 2026

(54) FLUORINE-BASED POLYMER COATING FILM, OPTICAL SUBSTRATE COMPRISING SAME, AND METHOD FOR MANUFACTURING OPTICAL SUBSTRATE

(71) Applicant: KOREA RESEARCH INSTITUTE OF CHEMICAL TECHNOLOGY, Daejeon (KR)

(72) Inventors: Eun-Ho SOHN, Daejeon (KR); Hyeon Jun HEO, Daejeon (KR); Won Wook SO, Daejeon (KR); In Joon PARK, Daejeon (KR); Bong Jun CHANG, Daejeon (KR); Sang Goo LEE, Daejeon (KR); Myoung Sook LEE, Daejeon (KR); Shin Hong YOOK, Daejeon (KR); Ju Hyeon KIM, Daejeon (KR); Ji Hoon BAIK, Daejeon (KR); Myung Seok OH, Daejeon (KR); Jong Min KIM, Daejeon (KR)

(73) Assignee: KOREA RESEARCH INSTITUTE OF CHEMICAL TECHNOLOGY, Daejeon (KR)

(21) Appl. No.: 19/659,912

(22) Filed: Apr. 27, 2026

Related U.S. Application Data
(63) Continuation of application No. 18/259,508, filed on Dec. 28, 2021.

(30) Foreign Application Priority Data
Dec. 28, 2020 (KR) 10-2020-0184218

(51) Int. Cl. C09D 127/16; C08J 5/18; C09D 7/63

(52) U.S. Cl. CPC C09D 127/16; C08J 5/18; C09D 7/63; C08J 2327/16

(57) ABSTRACT

The present invention relates to a fluorine-based polymer coating film, an optical substrate comprising same, and a method for manufacturing the optical substrate, and provides a fluorine-based polymer coating film which is formed from fluorine-based polymer nanoparticles coming in contact and being bound to each other, and which is coated on a substrate to improve infrared transmittance. The fluorine-based polymer coating film according to the present invention has improved infrared transmittance, and since the size of the fluorine-based polymer nanoparticles is controlled to control the ultraviolet-infrared transmittance, transmission wavelength selectivity can be improved.

### CROSS-REFERENCE TO RELATED APPLICATIONS

This application is a continuation of U.S. National Stage application Ser. No. 18/259,508, filed Sep. 7, 2023, which is based on International Application No. PCT/KR2021/019999, filed Dec. 28, 2021, which claims the benefit of Korean Application No. KR 10-2020-0184218, filed Dec. 28, 2020. These applications are hereby incorporated by reference in their entireties.

### BACKGROUND OF THE INVENTION

### 1. Field of the Invention

The present invention relates to a fluorine-based polymer coating film, an optical substrate comprising same, and a method for manufacturing the optical substrate.

### 2. Description of the Related Art

Organic/inorganic particles are used in various industrial fields such as optics and biomedicine, and studies on modifying the surface of hydrocarbon-based or inorganic particles with fluorine are actively conducted to improve surface and interface properties.

Polymer microparticles are used for modification and improvement of various materials by utilizing the structural characteristics of the microparticles, such as a large specific surface area. The main applications include toner additives, binder materials for paints, additives for powder coating materials, metal coating materials, water repellent coating materials, automotive materials, and building materials.

In addition, fluorine-based polymers are substances having properties such as low surface energy, water repellency, lubricity, and low refractive index along with excellent heat resistance, chemical resistance, and weather resistance, and have been widely used throughout the industry from household products.

Polyvinylidene fluoride resin microparticles, a type of fluorine-based polymer, also have excellent weather resistance, stain resistance, solvent resistance, water resistance, moisture resistance, etc., and are suitably used as anti-fouling materials in printing presses, toner applications, and resins for weather or water-resistant paints.

On the other hand, technologies that increase light transmittance and reduce reflection are widely used for the purpose of increasing the efficiency of related devices in the optical and optoelectronic fields. Accordingly, research on materials having a layer structure and a low refractive index for realizing excellent optical properties is being actively conducted. In particular, research on technologies to increase light permeability and reduce reflection through a surface structure in which a refractive index gradually decreases by using a construct smaller than the wavelength of light is also in progress, and organic/inorganic particles are widely used for this purpose. However, when using inorganic particles, a high heat treatment temperature is required, and studies have been conducted on modifying the surface of inorganic particles with fluorine to improve surface and interface properties (water repellency, weather resistance, etc.), but toxic chemicals are mainly used in the process.

Thus, the present inventors tried to develop a fluorine-based polymer coating film with improved light transmittance in visible or infrared areas and improved transmission wavelength selectivity using fluorine-based polymer nanoparticles sized to have excellent physicochemical and surface/interfacial properties, manufactured by a method that does not involve a fluorine surface modification process requiring high heat treatment temperatures and toxic chemicals, and as a result, the present invention was completed.

### BRIEF SUMMARY OF THE INVENTION

It is an object of the present invention to provide a fluorine-based polymer coating film, an optical substrate comprising the same, and a method for manufacturing the optical substrate.

To achieve the above object, in an aspect of the present invention, the present invention provides a fluorine-based polymer coating film which is formed from fluorine-based polymer nanoparticles coming in contact and being bound to each other, and which is coated on a substrate to improve infrared transmittance.

In another aspect of the present invention, the present invention provides an optical substrate comprising an optical substrate and the fluorine-based polymer coating film of claim 1 coated on the substrate.

In another aspect of the present invention, the present invention provides a method for manufacturing an optical substrate comprising the following steps:
a step of applying a dispersion in which fluorine-based polymer nanoparticles are dispersed on an optical substrate; and
a step of heat-treating the applied dispersion.

### Advantageous Effect

The fluorine-based polymer coating film according to the present invention has improved infrared transmittance, and since the size of the fluorine-based polymer nanoparticles is controlled to control the ultraviolet-infrared transmittance, transmission wavelength selectivity can be improved.

### BRIEF DESCRIPTION OF THE DRAWINGS

FIG. 1a is an image of PVDF nanoparticles according to Example 1 of the present invention observed with a scanning electron microscope (SEM), and a graph showing the results of analyzing by dynamic light scattering (DLS).

FIG. 1b is an image of PVDF nanoparticles according to Example 2 of the present invention observed with a scanning electron microscope (SEM), and a graph showing the results of analyzing by dynamic light scattering (DLS).

FIG. 1c is an image of PVDF nanoparticles according to Example 3 of the present invention observed with a scanning electron microscope (SEM), and a graph showing the results of analyzing by dynamic light scattering (DLS).

FIG. 1d is an image of PVDF nanoparticles according to Example 4 of the present invention observed with a scanning electron microscope (SEM), and a graph showing the results of analyzing by dynamic light scattering (DLS).

FIG. 2a is an image of the coating film of Example 1 of the present invention observed with a scanning electron microscope (SEM).

FIG. 2b is an image of the coating film of Example 2 of the present invention observed with a scanning electron microscope (SEM).

FIG. 2c is an image of the coating film of Example 3 of the present invention observed with a scanning electron microscope (SEM).

FIG. 2d is an image of the coating film of Example 4 of the present invention observed with a scanning electron microscope (SEM).

FIG. 3 is a graph showing the results of analyzing the transmittance of the coating films of Examples 1 to 4 of the present invention.

FIG. 4 is a graph showing the results of analyzing the transmittance of the coating film of Example 4 additionally heat-treated at 100° C. according to Experimental Example 2 of the present invention.

FIG. 5 is a graph showing the results of analyzing the transmittance of the coating film of Example 4 additionally heat-treated at 130° C. according to Experimental Example 2 of the present invention.

### DETAILED DESCRIPTION OF THE INVENTION

Hereinafter, the present invention is described in detail.

The embodiments of this invention can be modified in various other forms, and the scope of the present invention is not limited to the embodiments described below. It is well understood by those in the art who has the average knowledge on this field that the embodiments of the present invention are given to explain the present invention more precisely. In addition, the “inclusion” of an element throughout the specification does not exclude other elements, but may include other elements, unless specifically stated otherwise.

Throughout the specification, ‘ultraviolet region’ refers to ‘wavelength range of 300 nm to 400 nm’, ‘visible region’ refers to ‘wavelength range of 400 nm to 800 nm’, and ‘infrared region’ refers to ‘wavelength range of 800 nm to 2000 nm’.

In an aspect of the present invention, the present invention provides a fluorine-based polymer coating film which is formed from fluorine-based polymer nanoparticles coming in contact and being bound to each other, and which is coated on a substrate to improve infrared transmittance.

Hereinafter, the fluorine-based polymer coating film provided in an aspect of the present invention will be described in detail.

The fluorine-based polymer coating film provided in an aspect of the present invention is a coating film formed from fluorine-based polymer nanoparticles coming in contact and being bound to each other. The coating may be coated on a substrate, preferably an optical substrate, to improve transmittance in the infrared region.

The fluorine-based polymer nanoparticles may have a size of 50 nm to 300 nm. When the size of the fluorine-based polymer nanoparticles is less than 50 nm, the solid concentration of the fluorine-based polymer nanoparticle dispersion is remarkably low, and thus there may be a problem in preparing a coating film having an appropriate particle density. On the other hand, when the size of the nanoparticles exceeds 300 nm, the dispersion stability of the fluorine-based polymer nanoparticle dispersion is significantly lowered, and thus there may be a problem in preparing a uniform coating film.

The fluorine-based polymer coating film may further improve transmittance in the visible region.

The fluorine-based polymer nanoparticles may preferably have a size of 50 nm to 150 nm, preferably 60 nm to 130 nm.

In one embodiment, the nanoparticles of the fluorine-based polymer coating film may have a size of 65.9 nm or 118.6 nm, and may have higher transmittance than a glass substrate in a wavelength range of 400 nm to 800 nm.

The fluorine-based polymer coating film may further improve transmittance in the visible region and further reduce transmittance in the infrared region.

The fluorine-based polymer nanoparticles may preferably have a size of 80 nm to 150 nm, more preferably 90 nm to 140 nm, and most preferably 100 nm to 130 nm.

In one embodiment, the nanoparticles of the fluorine-based polymer coating film may have a size of 118.6 nm, may have lower transmittance than a glass substrate in the wavelength range of 300 nm to 400 nm, and may have improved transmittance than a glass substrate in the wavelength range of 400 nm to 800 nm.

The fluorine-based polymer can be any one selected from the group consisting of a homopolymer (PVDF) of vinylidene fluoride (VDF), a copolymer with a fluorine-based vinyl monomer, and a fluorine-containing acrylic polymer.

The fluorine-based vinyl monomer may be HFP or CTFE.

The fluorine-based polymer coating film may improve the transmittance of the substrate on which the coating film is formed in the infrared region, compared to the transmittance of the substrate itself in the infrared region.

The infrared region may be in the range of 800 nm to 2000 nm, preferably in the range of 1000 nm to 2000 nm.

The size of the fluorine-based polymer nanoparticles forming the fluorine-based polymer coating film is preferably 50 nm to 300 nm in the wavelength range of 800 nm to 2000 nm.

For example, in one embodiment, the size of the polymer nanoparticles may be 65.9 nm, 118.6 nm, 173.0 nm, or 232.0 nm, and the polymer nanoparticles may have the transmittance equal to or better (90% or more) than that of the glass substrate itself in the wavelength range of 800 nm to 2000 nm.

The fluorine-based polymer coating film may reduce the transmittance of the substrate on which the coating film is formed in the ultraviolet region, compared to the transmittance of the substrate itself in the ultraviolet region.

The ultraviolet region may be in the range of 300 nm to 400 nm.

The size of the fluorine-based polymer nanoparticles forming the fluorine-based polymer coating film is preferably 80 nm to 300 nm in the wavelength range of 300 nm to 400 nm.

For example, in one embodiment, the size of the polymer nanoparticles may be 173.0 nm or 232.0 nm, and the polymer nanoparticles may have a transmittance reduced by about 5 to 10% compared to the transmittance of the glass substrate itself in the wavelength range of 300 nm to 400 nm.

The size of the fluorine-based polymer nanoparticles forming the fluorine-based polymer coating film is preferably 80 nm to 150 nm, more preferably 90 nm to 140 nm, and most preferably 100 nm to 130 nm in the wavelength range of 400 nm to 800 nm.

For example, in one embodiment, the polymer nanoparticles may have a size of 118.6 nm and a transmittance of 90% or more in the wavelength range of 400 nm to 800 nm.

In addition, the size of the fluorine-based polymer nanoparticles forming the fluorine-based polymer film is preferably 50 nm to 300 nm, more preferably 80 nm to 300 nm, more preferably 150 nm to 300 nm, and most preferably 180 nm to 300 nm in the wavelength range of 1000 nm to 2000 nm.

For example, in one embodiment, the polymer nanoparticles may have a size of 232.0 nm and a transmittance of 93% or more in the wavelength range of 1000 nm to 2000 nm.

In addition, the thickness of the fluorine-based polymer coating film may be 50 nm to 300 nm.

The fluorine-based polymer coating film according to the present invention has improved infrared transmittance, and since the size of the fluorine-based polymer nanoparticles is controlled to control the ultraviolet-infrared transmittance, transmission wavelength selectivity can be improved.

In another aspect of the present invention, the present invention provides an optical substrate comprising an optical substrate and the fluorine-based polymer coating film provided in one aspect of the present invention coated on the substrate.

Since the fluorine-based polymer coating film provided in one aspect of the present invention is the same as described above, a detailed description thereof will be omitted hereinafter.

The optical substrate can be any one selected from the group consisting of a LIDAR distance sensor, a biometric sensor, and an infrared transmission lens.

The fluorine-based polymer coating film according to the present invention is coated on the optical substrate, improves infrared transmittance, and since the size of the fluorine-based polymer nanoparticles forming the fluorine-based polymer coating film is controlled to control the ultraviolet-infrared transmittance, transmission wavelength selectivity can be improved.

In another aspect of the present invention, the present invention provides a method for manufacturing an optical substrate comprising the following steps:
a step of applying a dispersion in which fluorine-based polymer nanoparticles are dispersed on an optical substrate; and
a step of heat-treating the applied dispersion.

Hereinafter, the method for manufacturing an optical substrate provided in another aspect of the present invention will be described in detail step by step.

The method for manufacturing an optical substrate of the present invention includes a step of applying a dispersion in which fluorine-based polymer nanoparticles are dispersed on an optical substrate.

The step of applying the dispersion in which fluorine-based polymer nanoparticles are dispersed on the optical substrate can be performed by spin-coating at a rotation speed of 1000 rpm to 3000 rpm.

The method for manufacturing an optical substrate of the present invention includes a step of heat-treating the applied dispersion.

The above step is a step of removing the solvent included in the dispersion and allowing the fluorine-based polymer nanoparticles to contact and bind to each other and to be well coated on the substrate.

The heat treatment can be performed at a temperature range of 50° C. to 150° C.

Hereinafter, the present invention will be described in detail by the following examples. However, the following examples are only for illustrating the present invention, and the contents of the present invention are not limited thereto

### <Example 1> Preparation of PVDF Polymer Film

### Preparation of Polyvinylidene Fluoride (PVDF) Nanoparticles

A solution obtained by mixing 0.14 g of sodium persulfate as a radical initiator and 300 g of distilled water was added to a 1 L high-pressure reactor, and allowed to reach a temperature of 82° C. and a pressure of 19.5 bar. Then, while stirring the solution at a rate of 300 rpm and adding vinylidene fluoride (VDF) at a rate of 0.3 g/minute or less, a polymerization reaction proceeded for 12 minutes to prepare PVDF nanoparticles.

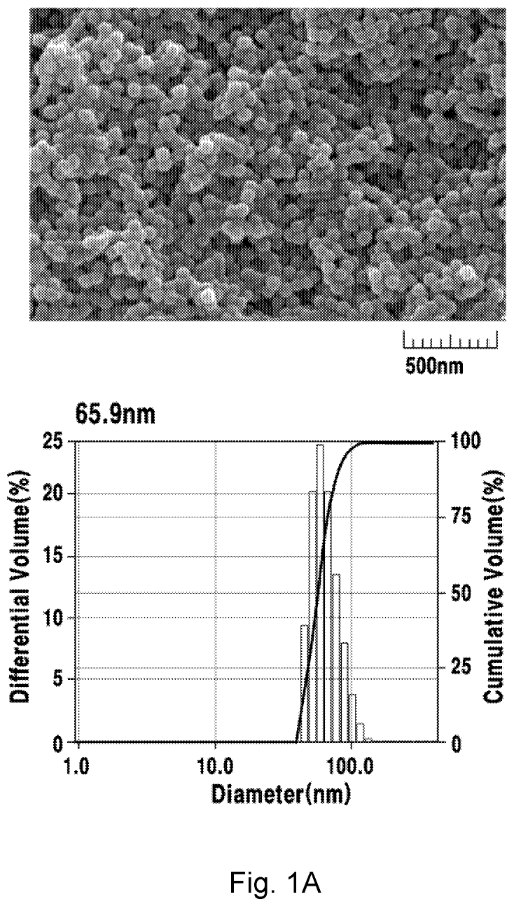

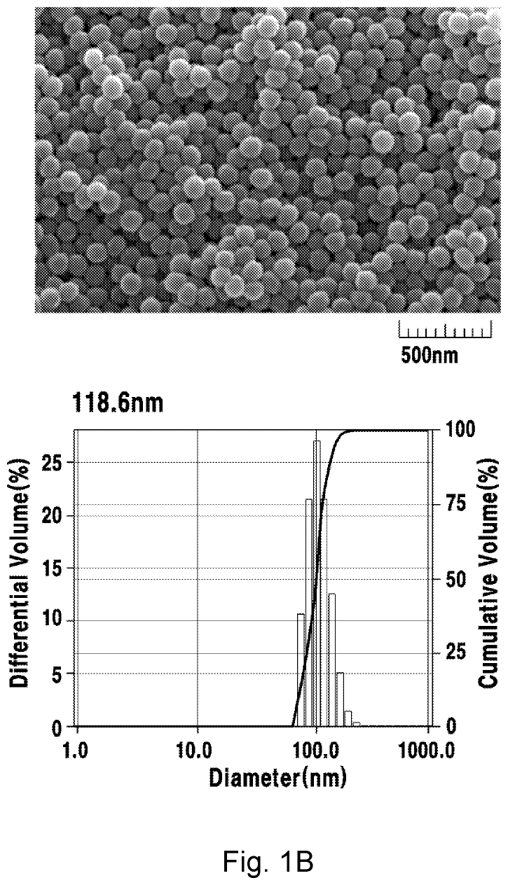

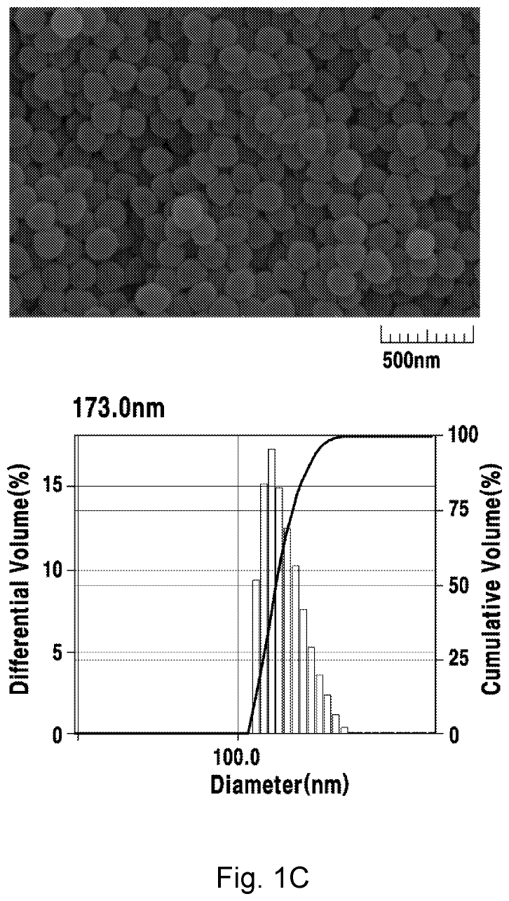

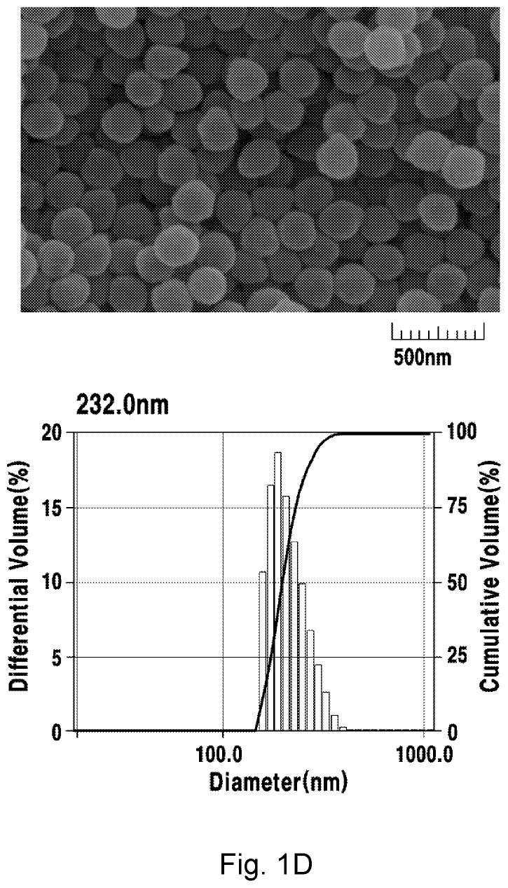

As a result of observation with a scanning electron microscope (SEM), it was confirmed that the prepared PVDF particles were formed in the form of nanoparticles, and as a result of measurement by dynamic light scattering (DLS), it was confirmed that the particles had a size of about 65.9 nm (FIG. 1a).

The weight average molecular weight (Mw), PDI value, and melting point (Tm) of the PVDF nanoparticles prepared in Example 1 and Examples 1 to 4 below are shown in Table 1 below.

TABLE 1

| | Mw(×10³) | PDI = (Mw/Mn) | Tm(° C.) (ΔH, J/g) |
|---|---|---|---|
| Example 1 | 461 | 3.5 | 165.3(51.1) |
| Example 2 | 544 | 2.6 | 163.8(45.9) |
| Example 3 | 461 | 3.0 | 164.5(46.9) |
| Example 4 | 495 | 3.2 | 163.4(45.0) |

### Formation of Polyvinylidene Fluoride (PVDF) Nanoparticle Coating Film

The prepared PVDF nanoparticle dispersion was diluted to a concentration of 0.8 weight % using isopropyl alcohol (IPA), and then spin-coated on a glass substrate at 2000 rpm for 60 seconds.

The spin-coated dispersion was heat-treated at a temperature of 100° C. to form a PVDF nanoparticle coating film.

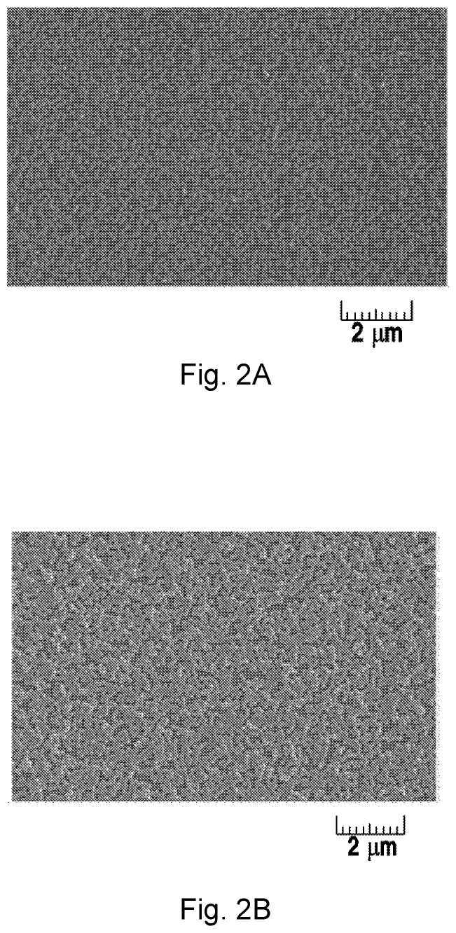

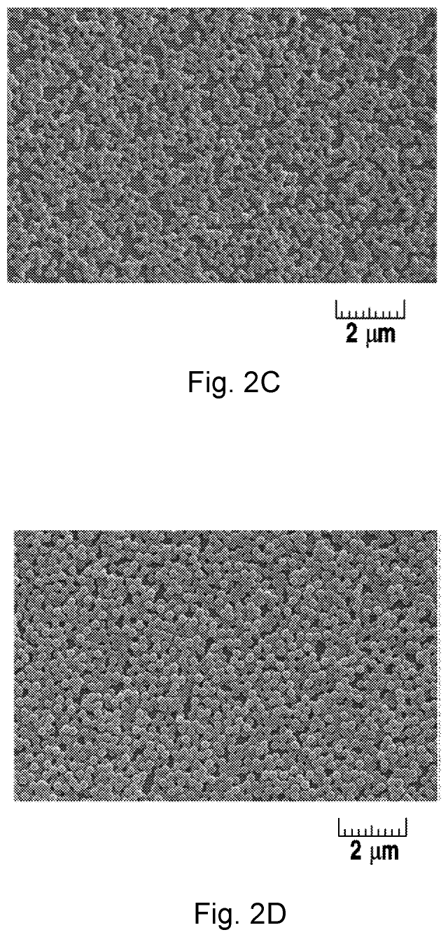

The formed PVDF nanoparticle coating film was observed with a scanning electron microscope (SEM). As a result, it was confirmed that spherical nanoparticles were combined in contact with each other and coated well on the glass substrate (FIG. 2a).

### <Example 2> Preparation of PVDF Polymer Film

### Preparation of Polyvinylidene Fluoride (PVDF) Nanoparticles

A solution obtained by mixing 0.14 g of sodium persulfate as a radical initiator and 300 g of distilled water was added to a 1 L high-pressure reactor, and allowed to reach a temperature of 82° C. and a pressure of 19.5 bar. Then, while stirring the solution at a rate of 300 rpm and adding vinylidene fluoride (VDF) at a rate of 0.3 g/minute or less, a polymerization reaction proceeded for 49 minutes to prepare PVDF nanoparticles.

As a result of observation with a scanning electron microscope (SEM), it was confirmed that the prepared PVDF particles were formed in the form of nanoparticles, and as a result of measurement by dynamic light scattering (DLS), it was confirmed that the particles had a size of about 118.6 nm (FIG. 1b).

### Formation of Polyvinylidene Fluoride (PVDF) Nanoparticle Coating Film

The prepared PVDF nanoparticle dispersion was diluted to a concentration of 3.0 weight % using isopropyl alcohol (IPA), and then spin-coated on a glass substrate at 2000 rpm for 60 seconds.

The spin-coated dispersion was heat-treated at a temperature of 100° C. to form a PVDF nanoparticle coating film.

The formed PVDF nanoparticle coating film was observed with a scanning electron microscope (SEM). As a result, it was confirmed that spherical nanoparticles were combined in contact with each other and coated well on the glass substrate (FIG. 2b).

### <Example 3> Preparation of PVDF Polymer Film

### Preparation of Polyvinylidene Fluoride (PVDF) Nanoparticles

A solution obtained by mixing 0.56 g of sodium persulfate as a radical initiator and 300 g of distilled water was added to a 1 L high-pressure reactor, and allowed to reach a temperature of 82° C. and a pressure of 19.5 bar. Then, while stirring the solution at a rate of 300 rpm and adding vinylidene fluoride (VDF) at a rate of 0.4 g/minute or less, a polymerization reaction proceeded for 75 minutes to prepare PVDF nanoparticles.

As a result of observation with a scanning electron microscope (SEM), it was confirmed that the prepared PVDF particles were formed in the form of nanoparticles, and as a result of measurement by dynamic light scattering (DLS), it was confirmed that the particles had a size of about 173.0 nm (FIG. 1c).

### Formation of Polyvinylidene Fluoride (PVDF) Nanoparticle Coating Film

The prepared PVDF nanoparticle dispersion was diluted to a concentration of 2.0 weight % using isopropyl alcohol (IPA), and then spin-coated on a glass substrate at 2000 rpm for 60 seconds.

The spin-coated dispersion was heat-treated at a temperature of 100° C. to form a PVDF nanoparticle coating film.

The formed PVDF nanoparticle coating film was observed with a scanning electron microscope (SEM). As a result, it was confirmed that spherical nanoparticles were combined in contact with each other and coated well on the glass substrate (FIG. 2c).

### <Example 4> Preparation of PVDF Polymer Film

### Preparation of Polyvinylidene Fluoride (PVDF) Nanoparticles

A solution obtained by mixing 0.98 g of sodium persulfate as a radical initiator and 300 g of distilled water was added to a 1 L high-pressure reactor, and allowed to reach a temperature of 82° C. and a pressure of 19.5 bar. Then, while stirring the solution at a rate of 300 rpm and adding vinylidene fluoride (VDF) at a rate of 0.6 g/minute or less, a polymerization reaction proceeded for 172 minutes to prepare PVDF nanoparticles.

As a result of observation with a scanning electron microscope (SEM), it was confirmed that the prepared PVDF particles were formed in the form of nanoparticles, and as a result of measurement by dynamic light scattering (DLS), it was confirmed that the particles had a size of about 232.0 nm (FIG. 1d).

### Formation of Polyvinylidene Fluoride (PVDF) Nanoparticle Coating Film

The prepared PVDF nanoparticle dispersion was diluted to a concentration of 4.0 weight % using isopropyl alcohol (IPA), and then spin-coated on a glass substrate at 2000 rpm for 60 seconds.

The spin-coated dispersion was heat-treated at a temperature of 100° C. to form a PVDF nanoparticle coating film.

The formed PVDF nanoparticle coating film was observed with a scanning electron microscope (SEM). As a result, it was confirmed that spherical nanoparticles were combined in contact with each other and coated well on the glass substrate (FIG. 2d).

### <Experimental Example 1> Evaluation of Optical Properties of Polymer Film

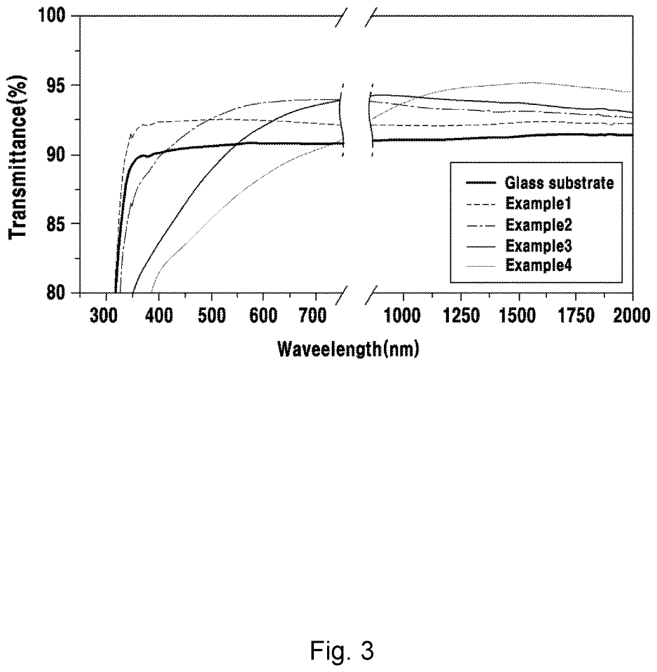

In order to evaluate the optical properties of the polymer coating film provided in one aspect of the present invention, the following experiment was conducted. The transmittance of the polymer coating films or polymer films prepared in Examples 1 to 4 was measured, and the results are shown in FIG. 3.

FIG. 3 is a graph showing the results of analyzing the transmittance of the coating films of Examples 1 to 4 of the present invention.

As shown in FIG. 3, the polymer coating film of Example 1 (65.7 nm) showed an improved transmittance as a whole compared to the glass substrate in the wavelength range of 300 nm to 2000 nm.

In addition, compared to the transmittance of the glass substrate itself, the transmittance was further reduced in the UV wavelength range of 300 nm to 400 nm when the polymer coating films of Examples 2 to 4 were formed. In the case of the polymer coating film of Example 4 with a large particle size, it was confirmed that the UV transmittance was the lowest.

In the visible light wavelength range of 400 nm to 800 nm, it was confirmed that the transmittance of the glass substrate on which the polymer coating film of Examples 1 and 2 was formed was improved compared to the transmittance of the glass substrate itself.

Next, in the infrared wavelength range of 800 nm to 2000 nm, the transmittance of the glass substrate on which the polymer coating film of Examples 1 to 4 was formed was improved compared to the transmittance of the glass substrate itself, which was found to be excellent. In particular, the ultraviolet transmittance of the polymer coating film of Example 4 (232.0 nm) was found to be the best in the wavelength range of 1000 nm to 2000 nm.

Compared to the glass substrate, the polymer coating film of Example 1 (particle size: 65.7 nm) showed an increase in transmittance in the entire wavelength range of 300 nm to 2000 nm.

The polymer coating film of Example 2 (particle size: 118.6 nm) showed reduced transmittance in the ultraviolet region and improved transmittance in the visible and infrared regions compared to the glass substrate.

In addition, it was found that the transmittance of the polymer coating films of Examples 1 to 4 was improved in the infrared region. Accordingly, it was confirmed that the polymer composite film made of fluorine-based polymer nanoparticles whose size is controlled provided in one aspect of the present invention can be applied to a LIDAR distance sensor, a biometric sensor, an infrared transmission lens, and the like.

### <Experimental Example 2> Evaluation of Durability

In order to evaluate the durability of the polymer coating film provided in one aspect of the present invention, the following experiment was performed.

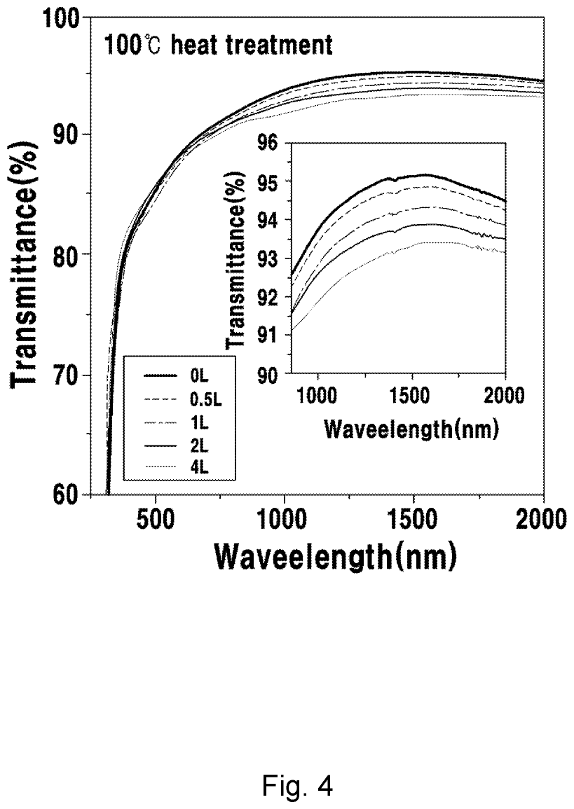

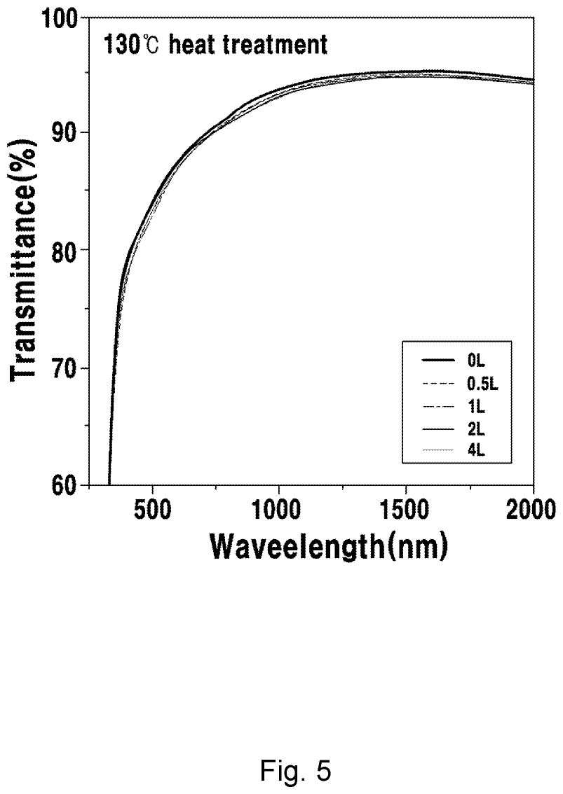

A water jet experiment was conducted using 0.5 to 4 L of water for the coating film obtained by additionally heat-treating the PVDF nanoparticle coating film prepared in Example 4 at 100° C. and 130° C. The results are shown in FIGS. 4 and 5.

FIG. 4 is a graph showing the results of analyzing the transmittance of the coating film of Example 4 additionally heat-treated at 100° C., and FIG. 5 is a graph showing the results of analyzing the transmittance of the coating film of Example 4 additionally heat-treated at 130° C.

As shown in FIG. 4, when the polymer coating films of Examples 1 to 4 were heat treated at 100° C., the transmittance decreased slightly as the amount of water increased.

In addition, as shown in FIG. 5, when the polymer coating films of Examples 1 to 4 were additionally heat-treated at 130° C., the transmittance performance was maintained even though up to 4 L of water was used.

From the above results, it was confirmed that the polymer coating film provided in one aspect of the present invention can secure durability through heat treatment at a relatively low temperature (100° C. to 130° C.) without performing complicated methods such as heat treatment at a high temperature exceeding 400° C. or chemical treatment using a crosslinking agent to secure the stability of the conventional organic and inorganic particle coating film.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

When a group of materials, compositions, components or compounds is disclosed herein, it is understood that all individual members of those groups and all subgroups thereof are disclosed separately. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. Additionally, the end points in a given range are to be included within the range. In the disclosure and the claims, “and/or” means additionally or alternatively. Moreover, any use of a term in the singular also encompasses plural forms.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

One of ordinary skill in the art will appreciate that starting materials, device elements, analytical methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. Headings are used herein for convenience only.

All publications referred to herein are incorporated herein to the extent not inconsistent herewith. Some references provided herein are incorporated by reference to provide details of additional uses of the invention. All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art.

What is claimed is:

1. A method of improving transmittance of an optical substrate in an infrared region comprising coating a fluorine-based polymer coating film on the optical substrate, wherein the fluorine-based polymer coating film is formed from fluorine-based polymer nanoparticles coming in contact and being bound to each other, and thereby improving transmittance of the optical substrate in the infrared region,
wherein the fluorine-based polymer nanoparticles have a size of 50 nm to 300 nm.

2. The method according to claim 1, wherein the infrared region is in the range of 800 nm to 2000 nm.

3. The method according to claim 1, wherein the fluorine-based polymer coating film further improves transmittance in the visible light region.

4. The method according to claim 1, wherein the fluorine-based polymer nanoparticles have a size of 80 nm to 150 nm.

5. The method according to claim 1, wherein the fluorine-based polymer is any one selected from the group consisting of a homopolymer (PVDF) of vinylidene fluoride (VDF), a copolymer with a fluorine-based vinyl monomer, and a fluorine-containing acrylic polymer.

6. The method according to claim 1, wherein the fluorine-based polymer coating film improves the transmittance of the substrate on which the coating film is formed in the infrared region, compared to the transmittance of the substrate itself in the infrared region.

7. The method according to claim 1, wherein the fluorine-based polymer coating film reduces the transmittance of the substrate on which the coating film is formed in the ultraviolet region, compared to the transmittance of the substrate itself in the ultraviolet region.

8. The method according to claim 1, wherein the thickness of the fluorine-based polymer coating film is 50 nm to 300 nm.

9. The method according to claim 1, wherein the optical substrate is any one selected from the group consisting of a LIDAR distance sensor, a biometric sensor, and an infrared transmission lens.

10. The method according to claim 1, wherein coating the fluorine-based polymer coating film comprises:
a step of applying a dispersion in which fluorine-based polymer nanoparticles are dispersed on an optical substrate; and
a step of heat-treating the applied dispersion.
